(19) United States
(12) Patent Application Publication
(10) Pub. No.: US 2024/0230422 A9
(43) Pub. Date: Jul. 11, 2024

(54) TEMPERATURE-SENSING DATA PROCESSING MODULE AND TEMPERATURE SENSOR

(71) Applicant: GIGADEVICE SEMICONDUCTOR INC., Beijing (CN)

(72) Inventors: Yang Fan, Beijing (CN); Sanlin Liu, Beijing (CN); Keren Li, Beijing (CN)

(73) Assignee: GIGADEVICE SEMICONDUCTOR INC., Beijing (CN)

(21) Appl. No.: 18/127,819

(22) Filed: Mar. 29, 2023

(30) Foreign Application Priority Data
Oct. 24, 2022 (CN) 202211304061.8
Oct. 24, 2022 (CN) 202211304066.0

(51) Int. Cl. G01K 7/01

(52) U.S. Cl. CPC G01K 7/01

(57) ABSTRACT

Disclosure regards a temperature sensor and a temperature-sensing data processing module, including two counting units, each configured to set a reference clock signal and a frequency conversion signal to be a counting-clock signal and a counting-sample signal according to a control signal, wherein during a sampling period consisting of at least one signal cycle of the counting-sample signal, the two counting units count the numbers of rising edges and falling edges of the counting-clock signal; and a count-control unit configured to generate a doubled-frequency counting value based on a sum of the number of rising edges and the number of falling edges to generate a temperature value based on the doubled-frequency counting value and a temperature-frequency fitting function. Therefore, problems regarding temperature estimation errors in the prior art are effectively solved.

### CROSS REFERENCE TO RELATED APPLICATIONS

This application claims the priority of China Patent Applications No. 202211304066.0, titled as “TEMPERATURE-SENSING DATA PROCESSING MODULE AND TEMPERATURE SENSOR”, filed on Oct. 24, 2022, and No. 202211304061.8, titled as “FREQUENCY CONVERSION MODULE AND TEMPERATURE SENSOR”, filed on Oct. 24, 2022, the disclosures of which are incorporated herein by reference.

### FIELD OF THE INVENTION

The present disclosure relates to the field of signal conversion technologies, and more particularly, to a temperature-sensing data processing module and a temperature sensor.

### BACKGROUND OF THE INVENTION

In electronic control equipment, temperature sensing is a common physical feature sensing function, such as performing related control functions based on an output signal of a temperature sensor.

There are some technical solutions in the prior art. For example, the temperature is converted into a signal with a fixed frequency, and a reference clock signal with a known frequency is used for counting.

However, because a signal to be measuring frequency and the reference clock signal are completely asynchronous signals, significant errors will occur in estimating the temperature based on the frequency of the reference clock signal and a count value.

### SUMMARY OF THE INVENTION

The present disclosure provides a temperature-sensing data processing module and a temperature sensor.

One aspect of the present disclosure provides a temperature-sensing data processing module, which includes: two counting units, wherein each of the two counting units is configured to set one of a reference clock signal and a frequency conversion signal to be a counting-clock signal and the other of the reference clock signal and the frequency conversion signal to be a counting-sample signal according to a control signal, and during a sampling period consisting of at least one signal cycle of the counting-sample signal, one of the two counting units counts the number of rising edges of the counting-clock signal, and the other of the two counting units counts the number of falling edges of the counting-clock signal; and a count-control unit configured to generate a doubled-frequency counting value based on a sum of the number of rising edges and the number of falling edges and generate a temperature value based on the doubled-frequency counting value and a temperature-frequency fitting function.

Another aspect of the present disclosure provides a temperature sensor, which includes a frequency conversion module and a temperature-sensing data processing module as mentioned above, wherein the temperature-sensing data processing module is electrically connected to the frequency conversion module that is configured to generate the frequency conversion signal.

### BRIEF DESCRIPTION OF THE DRAWINGS

To more clearly illustrate technical solutions in embodiments of the present disclosure, drawings that need to be used in the description of the embodiments will be briefly introduced below. Obviously, the drawings in the following description are only some embodiments of the present disclosure. For those skilled in the art, other drawings can also be obtained based on these drawings without any creative effort.

FIG. 1 is a schematic block diagram of a temperature sensor according to an embodiment of the present disclosure.

FIG. 2 is a schematic diagram of a start-count signal and a stop-count signal according to an embodiment of the present disclosure.

FIG. 3 is a schematic diagram of a counting-clock signal and a counting-sample signal according to an embodiment of the present disclosure.

FIG. 4 is a schematic circuit diagram of a frequency conversion module according to an embodiment of the present disclosure.

FIG. 5 is a schematic diagram of a current-generating circuit with a positive temperature-to-frequency conversion function according to an embodiment of the present disclosure.

FIG. 6 is a schematic diagram of another current-generating circuit with a positive temperature-to-frequency conversion function according to an embodiment of the present disclosure.

FIG. 7 is a schematic circuit diagram of another frequency conversion module according to an embodiment of the present disclosure.

### THE DETAILED DESCRIPTION OF PREFERRED EMBODIMENTS

The following will clearly and completely describe the technical solutions in embodiments of the present disclosure with reference to drawings in the embodiments of the present disclosure. Obviously, described embodiments are only some of the embodiments of the present disclosure, but not all of them. Based on the embodiments of the present disclosure, all other embodiments obtained by those skilled in the art without creative efforts falls within the protection scope of the present disclosure.

In the description herein, it should be understood that an orientation or positional relationship indicated by the terms such as “center,” “longitudinal,” “transverse,” “length,” “width,” “thickness,” “upper,” “lower,” “front,” “rear,” “left,” “right,” “vertical,” “horizontal,” “top,” “bottom,” “inside,” “outside,” “clockwise,” and “counterclockwise” is based on the orientation or positional relationship shown in the drawings and is only for the convenience of describing the present disclosure and simplifying the description, rather than indicating or implying that a referred device or element has a specific orientation or is constructed and operates in a specific orientation. Therefore it should not be construed as a limitation of the present disclosure.

In the description herein, it should be understood that the terms “first” and “second” are merely used for descriptive purposes and cannot be interpreted as indicating or implying relative importance or implicitly specifying a quantity of indicated technical features. In this way, features defined as “first” or “second” may explicitly or implicitly include one or more of said features. In the description of the present disclosure, “plurality” means two or more, unless otherwise specifically defined.

Many different embodiments or examples are provided herein for implementing different configurations of the present disclosure. To simplify the content of the present disclosure, components and arrangements of specific examples are described below. Certainly, they are examples only and are not intended to limit the present disclosure. In addition, the present disclosure may repeat reference numerals and/or reference letters in different examples; such repetition is used for simplicity and clarity and does not indicate a relationship between the various embodiments and/or arrangements discussed. Furthermore, examples of various specific processes and materials are provided herein. Still, those ordinarily skilled in the art may recognize the application of other processes and/or the use of other materials.

In electronic control equipment, temperature sensing is a common physical feature sensing function, such as performing related control functions based on an output signal of a temperature sensor.

In one implementation, an embodiment of the disclosure provides a temperature-sensing data processing module. For example, the temperature-sensing data processing module can be applied to a temperature sensor to provide a temperature-based data processing function. It should be understood that the relevant descriptions are used to assist those skilled in the art to understand the present disclosure, but are not intended to limit the present disclosure.

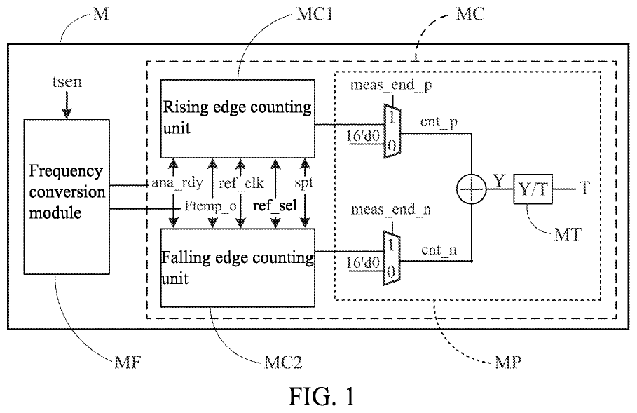

In one example, as shown in FIG. 1, the temperature sensor M includes a temperature-sensing data processing module MC. The temperature-sensing data processing module MC is electrically connected to a frequency conversion module MF. The frequency conversion module MF can generate a frequency conversion signal Ftemp_o according to a temperature value (such as obtained from the ambient temperature or a surface temperature of a specific object). For example, the frequency conversion signal Ftemp_o can be a signal in the form of a pulse wave. A frequency of the frequency conversion signal Ftemp_o is positively correlated with a temperature value to be the basis for temperature data outputted by the temperature sensor M.

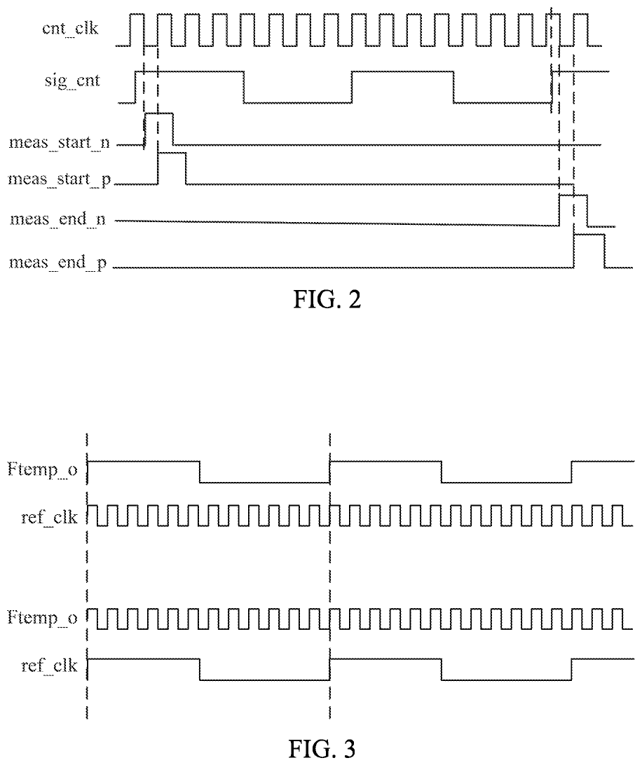

In an example, as shown in FIGS. 1 and 2, the temperature-sensing data processing module MC includes two counting units MC1, MC2, and a count-control unit MP. The counting units MC1, MC2, and the count-control unit MP may be an application-specific integrated circuit (ASIC), such as being designed using the hardware description language (HDL) and automated design tools. The counting units MC1 and MC2 can be configured to count rising and falling edges of the counting-clock signal related to temperature-sensing during a specific sampling period. The count-control unit MP can be configured to apply a specific function to generate temperature-sensing-related values according to a counting result.

For example, as shown in FIGS. 1 and 2, each of the counting units MC1 and MC2 can be configured to set one of a reference clock signal ref_clk and a frequency conversion signal Ftemp_o to be a counting-clock signal cnt_clk and the other of the reference clock signal ref_clk and the frequency conversion signal Ftemp_o to be a counting-sample signal sig_cnt according to a control signal ref_sel. For example, the control signal ref_sel can be configured by a user to indicate that one of the reference clock signal ref_clk and the frequency conversion signal Ftemp_o can be the counting-clock signal cnt_clk and the other of the reference clock signal ref_clk and the frequency conversion signal Ftemp_o can be the count sample signal sig_cnt.

For example, as shown in FIGS. 1 and 2, if the control signal ref_sel is in a high level or a logic “1”, the reference clock signal ref_clk can be the counting-clock signal cnt_clk, and the frequency conversion signal Ftemp_o can be the counting-sample signal sig_cnt. On the other hand, if the control signal ref_sel is in a low level or logic “0”, the reference clock signal ref_clk can be the counting-sample signal sig_cnt, and the frequency conversion signal Ftemp_o can be the counting-clock signal cnt_clk. However, they cannot be limited to the description here.

For example, as shown in FIGS. 1 and 2, a frequency of the counting-clock signal cnt_clk is higher than a frequency of the counting sampling signal sig_cnt, in response to a sampling period consisting of at least one signal cycle of the counting-sample signal, taking the sampling period being two signal cycles of the counting-sample signal as an example. In the sampling period, one (e.g., MC1) of the two counting units MC1 and MC2 can be served as a rising-edge counting unit to count the number of rising edges of the counting-clock signal, wherein the rising-edge means a level transition state in a pulse signal (such as a clock signal) being from a low-level state to a high-level state; and the other of the two counting units can be served as a falling-edge counting unit to count the number of falling edges of the counting-clock signal, wherein the falling-edge means another level transition state in a pulse signal being from a high-level state to a low-level state.

For example, as shown in FIGS. 1 and 2, the two counting units MC1 and MC2 can input a frequency conversion signal Ftemp_o and a reference clock signal ref_clk. For example, the reference clock signal ref_clk is a clock signal generated by a signal-generating circuit. For example, the frequency conversion signal Ftemp_o is generated by the frequency conversion module MF. The frequency conversion signal Ftemp_o can be matched with a frequency-converting ready signal ana_rdy. When the frequency-converting ready signal ana_rdy is in a specific state (such as a high level or logic “1”, but not limited to the description here, being also able to a low level or logic “0”), the frequency-converting ready signal ana_rdy can be used to indicate that a current state of the frequency conversion signal Ftemp_o is a valid state. For example, when the frequency-converting ready signal ana_rdy is in a high level, the two counting units MC1 and MC2 can perform counting-related functions according to the frequency conversion signal Ftemp_o. For example, each of the counting units MC1 and MC2 can set one of the reference clock signal ref_clk and the frequency conversion signal Ftemp_o to be the counting-clock signal cnt_clk and the other of the reference clock signal ref_clk and the frequency conversion signal Ftemp_o to be the counting-sample signal sig_cnt.

For example, as shown in FIGS. 1 and 2, the two counting units MC1 and MC2 can also input the number spt of the signal cycles of the counting-sample signal sig_cnt, wherein the number spt of the signal cycles can be appropriately adjusted according to actual needs. For example, the number of the signal cycles of the counting-sample signal sig_cnt may be one of numbers from 1 (0x01) to 15 (0x0F) but is not limited to the description here. In response to a sampling period consisting of at least one of the signal cycles of the counting-sample signal sig_cnt (e.g., the number of signal cycles is expressed as spt), for example, the count-control unit MP can also be configured to generate a sampling-valid signal (e.g., in a high level, not shown in the figure) to be the basis for counting the number of the rising-edges of the counting-clock signal but is not limited to the description here. In FIG. 2, the number of the signal cycles of the counting-sample signal sig_cnt is two (i.e., the sampling period is two signal cycles of the counting-sample signal sig_cnt) is taken as an example, in the sampling period, one of the two counting units (such as MC1) counts the number of rising edges of the counting-clock signal cnt_clk, and the other of the two counting units (such as MC2) counts the number of falling edges of the counting-clock signal cnt_clk.

For example, as shown in FIG. 2, the sampling period of the counting-sample signal sig_cnt has a beginning time point and an ending time point on a time axis used to represent a beginning feature and an ending feature of the sampling period. For example, the sampling period of the counting-sample signal sig_cnt has two beginning characteristics corresponding to the rising edges and the falling edges of the counting-clock signal cnt_clk on the time axis. For example, in response to detecting the rising edge of the counting-sample signal sig_cnt for the first time at the rising edges of the counting-clock signal cnt_clk (e.g., in response to detecting the counting-sample signal sig_cnt is in a low level first and then a high level at adjacent two of the rising edges of the counting-clock signal cnt_clk, it is considered that the rising edge of the counting-sample signal sig_cnt is detected), the count-control unit MP can be configured to determine that a first beginning of the sampling period is detected. Correspondingly, a rising start-count signal meas_start_p (such as a single high-level pulse wave) can also be generated as the basis for operations of correlation circuits. For example, in response to detecting the rising edge of the counting-sample signal sig_cnt for the first time at the falling edges of the counting-clock signal cnt_clk (e.g., in response to detecting the counting-sample signal sig_cnt is in a low level first and then a high level at adjacent two of the falling edges of the counting-clock signal cnt_clk, it is considered that the rising edge of the counting-sample signal sig_cnt is detected), the count-control unit MP can be configured to determine that a second beginning of the sampling period is detected. Correspondingly, a falling start-count signal meas_start_n (such as a single high-level pulse wave) can also be generated as the basis for operations of related circuits. Regarding how to detect the rising edges of the counting-sample signal sig_cnt at the rising edges/falling edges of the counting-clock signal cnt_clk, as mentioned above, except for sampling the level of the counting-sample signal sig_cnt at the rising edges/falling edges of adjacent two of the cycles of the counting-clock signal cnt_clk to determine whether the counting-sample signal sig_cnt has a rising-edge transition, other methods for determining whether the counting-sample signal sig_cnt has the rising edge transition can be applied. The present disclosure is not limited to the description here so long as the purpose is to detect the two beginning of the sampling period.

On the other hand, as shown in FIG. 2, the sampling period of the counting-sample signal sig_cnt has two ending characteristics corresponding to the rising edges and the falling edges of the counting-clock signal cnt_clk on the time axis. For example, after N signal cycles of the counting-sample signal sig_cnt, the sampling period is terminated, wherein N (e.g., N=2) is the number of the signal cycles of the counted sample signal sig_cnt included in the sampling period. For example, in response to detecting the rising edge of the counting-sample signal sig_cnt for the (N+1)th time at the rising edges of the counting-clock signal cnt_clk, the count-control unit MP can be configured to determine that a first ending of the sampling period is detected. Correspondingly, a rising stop-count signal meas_end_p (such as a single high-level pulse wave) can also be generated as the basis for operations of related circuits. For example, in response to detecting the rising edge of the counting-sample signal sig_cnt for the (N+1)th time at the falling edges of the counting-clock signal cnt_clk, the count-control unit MP can be configured to determine that a second ending of the sampling period is detected. Correspondingly, a falling stop-count signal meas_end_n (such as a single high-level pulse wave) can also be generated as the basis for operations of related circuits. Regarding how to detect the rising edges of the counting-sample signal sig_cnt at the rising edges/falling edges of the counting-clock signal cnt_clk, as mentioned above, the level (such as being in a low level first and then a high level) of the counting sampling signal can be sampled at the rising edges/falling edges of adjacent two of the cycles of the counting-clock signal cnt_clk to determine whether the counting-sample signal sig_cnt has a rising edge transition. The present disclosure is not limited to the description here, other methods for determining whether the counting-sample signal sig_cnt has the rising edge transition can be applied, so long as the purpose is to detect the two endings of the sampling period. Different from the detection of the two beginnings of the sampling period mentioned above, a counting judgment logic (not shown) can be provided to determine how many times the rising edge of the counting-sample signal sig_cnt is detected for this time. If this is the (N+1)th time, it is considered to detect a termination of the sampling period.

In one example, as shown in FIG. 2, in response to detecting the counting-sample signal sig_cnt being in a low level first and then a high level at adjacent two of the rising edges or adjacent two of the falling edges of the counting-clock signal cnt_clk, the count-control unit MP can be configured to determine that the (N+1)th rising edge of the counting-sample signal sig_cnt is detected and then determine that the first ending and the second ending of the sampling period occur respectively.

For example, as shown in FIGS. 1 and 2, one of the two counting units (such as MC1) can start counting the number of rising edges of the counting-clock signal cnt_clk according to the rising start-count signal meas_start_p and stop counting the number of rising edges of the counting-clock signal cnt_clk according to the rising stop-count signal meas_end_p. The other of the two counting units (such as MC2) can start counting the number of falling edges of the counting-clock signal cnt_clk according to the falling start-count signal meas_start_n and stop counting the number of falling edges of the counting-clock signal cnt_clk according to the falling stop-count signal meas_end_n. Therefore, the number of rising edges and the number of falling edges of the counting-clock signal cnt_clk can be used as a basis for estimating the temperature.

For example, as shown in FIGS. 1 and 2, the count-control unit MP can be configured to generate a doubled-frequency counting value Y according to a sum of the number of rising edges and the number of falling edges. For example, the number of the rising edge and the number of falling edges are temporarily stored and then added together. In one example, in response to the termination of the sampling period, the count-control unit MP can be configured to reset the doubled-frequency counting value Y to zero. For example, after the rising stop-count signal meas_end_p and the falling stop-count signal meas_end_n are received respectively, a temporary quantity cnt_p of the rising edges and a temporary quantity cnt_n of the falling edge can be respectively set to zero, such that the sum of the number of the rising edges and the number of the falling edges is zero. Namely, the doubled-frequency counting value Y is reset to zero.

Correspondingly, as shown in FIG. 1, the count-control unit MP can also be configured to generate a temperature value T according to the doubled-frequency counting value Y and a temperature-frequency fitting function MT. For example, the temperature-frequency fitting function is generated by fitting a plurality of temperature-frequency conversion relationship curves, such as a linear or curve function. A curve fitting method can be, for example, a least squares curve fitting method but it not limited to the description here.

For example, as shown in FIG. 1, according to a frequency difference between the frequency conversion signal Ftemp_o and the reference clock signal ref_clk, the temperature-frequency conversion relationship curves can be expressed in different forms.

For example, as shown in the upper part of FIG. 3, in response to the frequency of the reference clock signal ref_clk being higher than (or equal to) the frequency of the frequency conversion signal Ftemp_o, the temperature-frequency fitting function can be expressed as follows:

$$T = T 0 + ( ( \frac{2 \times F 1}{Y} ) \times N - U \times F 0 ) / E$$

wherein T is the temperature value, T0 is a reference temperature, F1 is the frequency of the reference clock signal, Y is the doubled-frequency counting value, N is the number of the signal periods of the counting-sample signal included in the sampling period, U is a frequency-unit conversion coefficient, F0 is a frequency value at the reference temperature, and E is a temperature-frequency conversion coefficient. For example, the temperature-frequency conversion coefficient can be obtained in a fitting process, in which the details can be understood by those skilled in the art and does not be repeatedly described here.

Alternatively, as shown in the lower part of FIG. 3, in response to the frequency of the reference clock signal ref_clk being lower than the frequency of the frequency conversion signal Ftemp_o, the temperature-frequency fitting function is expressed as follows:

$$T = T 0 + ( ( \frac{F 1}{N} ) \times Y / 2 - U \times F 0 ) / E$$

wherein T is the temperature value, T0 is a reference temperature, F1 is the frequency of the reference clock signal, Y is the doubled-frequency counting value, N is the number of the signal periods of the counting-sample signal included in the sampling period, U is a frequency-unit conversion coefficient, F0 is a frequency value at the reference temperature, and E is a temperature-frequency conversion coefficient.

In one aspect, the above-mentioned embodiment of the present disclosure provides a temperature-sensing data processing module, including: two counting units, wherein each of the two counting units is configured to set one of a reference clock signal and a frequency conversion signal to be a counting-clock signal and the other of the reference clock signal and the frequency conversion signal to be a counting-sample signal according to a control signal, and during a sampling period consisting of at least one signal cycle of the counting-sample signal, one of the two counting units counts the number of rising edges of the counting-clock signal, and the other of the two counting units counts the number of falling edges of the counting-clock signal; and a count-control unit configured to generate a doubled-frequency counting value based on a sum of the number of rising edges and the number of falling edges and generate a temperature value based on the doubled-frequency counting value and a temperature-frequency fitting function. Therefore, counting the rising and falling edges of the same signal frequency (e.g., the counting-sample signal) is equivalent to doubling the frequency of the counting-clock signal. In this way, the higher the frequency of the counting-clock signal, the smaller the sampling error, and the smaller the error counting measurement value. In such a way, it can be suitable for processing frequency conversion signals positively correlated with temperature and can be used to generate temperature-sensing values. Thus, counting errors can be reduced.

Optionally, in an embodiment, the temperature-frequency fitting function is generated by fitting a plurality of temperature-frequency conversion relationship curves. Therefore, by fitting the function generated by the plurality of temperature-frequency conversion relationship curves, an optimized temperature-frequency conversion relationship function can be found, which can be used as a basis for outputting temperature-sensing values, which can help reduce counting errors.

In another aspect, the embodiments mentioned above of the present disclosure provide a temperature sensor, which includes a frequency conversion module and a temperature-sensing data processing module as mentioned above, wherein the temperature-sensing data processing module is electrically connected to the frequency conversion module that is configured to generate the frequency conversion signal. Therefore, the frequency conversion signal can be used as the basis for generating the temperature value. Because the rising and falling edges of the same signal frequency (e.g., the counting-sample signal) are counted, it is equivalent to doubling the frequency of the counting-clock signal, reducing the sampling error. In addition, because only the same signal is counted, the situation of counting different signals is avoided, thereby reducing the error of the counting measurement value and improving the measurement accuracy.

Optionally, in an embodiment, a frequency of the frequency conversion signal is positively correlated with the temperature value. Therefore, because of the positive correlation between the frequency of the frequency conversion signal and the temperature value, intuitive frequency characteristics corresponding to the temperature are presented as the basis for subsequent temperature estimation. In addition, because the rising and falling edges of the same signal frequency (e.g., the counting sampling signal) are counted, it is equivalent to doubling the frequency of the counting-clock signal, reducing the sampling error. In addition, because only the same signal is counted, it can avoid counting different signals, thereby reducing counting errors and improving measurement accuracy.

It should be noted that the above-mentioned embodiments of the present disclosure provide the temperature-sensing data processing module, which uses two counting units to respectively count the rising and falling edges of the same signal frequency (such as from the counting-clock signal) and generates a temperature value based on the sum of the numbers of the rising and falling edges. In contrast, in a related example, e.g., two counting units are used to count a positive temperature coefficient voltage frequency and a bandgap reference voltage frequency from two identical voltage-to-frequency conversion circuits. Because a frequency signal to be measured (i.e., the positive temperature coefficient voltage frequency) and a reference frequency signal (i.e., the bandgap reference voltage frequency) are completely asynchronous signals, a significant error will occur when the temperature is calculated according to counting values of the reference frequency signal and the frequency signal to be measured. The temperature-sensing data processing module of the above-mentioned embodiments of the present disclosure counts the rising and falling edges of the same frequency conversion signal (such as a counting-sample signal) respectively, avoiding the situation of counting different signals. Thus, it can obtain beneficial effects such as reducing counting errors and improving measurement accuracy.

In another implementation solution, an embodiment of the present disclosure provides a frequency conversion module. For example, the frequency conversion module can be applied to a temperature sensor to provide a temperature-based frequency conversion function. It should be understood that relevant descriptions are used to assist in understanding the present disclosure to those skilled in the art but are not intended to limit the present disclosure.

In one example, as shown in FIG. 1, the temperature sensor M includes a frequency conversion module MF. The frequency conversion module MF is electrically connected to a temperature-sensing data processing module MC. For example, when a conversion-enabling signal tsen is in an enable state (such as in a high level or a low level), the frequency conversion module MF can output a frequency conversion signal Ftemp_o. The temperature-sensing data processing module MC can generate a temperature value T according to the frequency conversion signal Ftemp_o as the basis for temperature data outputted by the temperature sensor M.

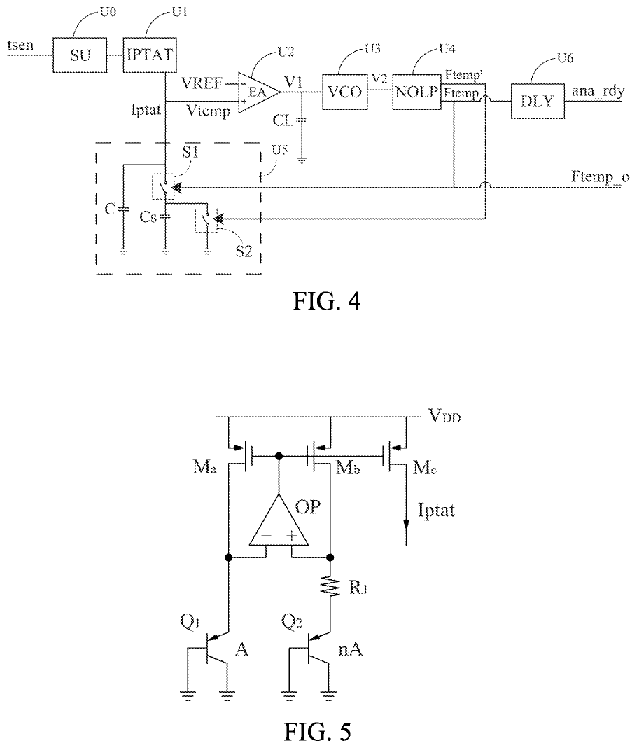

For example, as shown in FIG. 4, the frequency conversion module MF includes a positive-temperature-frequency conversion unit (IPTAT) U1, an operational amplifier (EA) U2, a voltage-controlled oscillator (VCO) U3, a non-overlapping signal generator (NOLP) U4, and a charging and discharging circuit U5. The positive-temperature-frequency conversion unit U1 can be configured to generate a positive-temperature-coefficient current Iptat whose magnitude is positively correlated with temperature.

As shown in FIG. 4, the operational amplifier U2 is electrically connected to the positive-temperature-frequency conversion unit U1. The operational amplifier U2 can be used to generate an operation-amplifying signal V1 according to a temperature voltage Vtemp and a reference voltage VREF. The voltage-controlled oscillator U3 is electrically connected to the operational amplifier U2. The voltage-controlled oscillator can be used to generate an oscillation signal V2 according to the operation-amplifying signal V1. The non-overlapping signal generator U4 is electrically connected to the voltage-controlled oscillator U3. The non-overlapping signal generator U4 can be used to generate a frequency conversion signal Ftemp and an inverted conversion signal Ftemp′ according to the oscillation signal V2, wherein a phase of the frequency conversion signal Ftemp is opposite to a phase of the inverted conversion signal Ftemp′, and the frequency conversion signal Ftemp can be regarded as the basis for a frequency conversion signal Ftemp_o outputted by the frequency conversion module MF. For example, a terminal outputting the frequency conversion signal Ftemp_o can be directly electrically connected to a node generating the frequency conversion signal Ftemp, but this is not a limit. For example, a waveform reforming module such as a D-type flip-flop (i.e., D Flip-Flop) can be provided between the terminal outputting the frequency conversion signal Ftemp_o and the node generating the frequency conversion signal Ftemp, such that a waveform of the frequency conversion signal Ftemp can be regularly adjusted to form the frequency conversion signal Ftemp_o. The charging and discharging circuit U5 is electrically connected to the positive-temperature-frequency conversion unit U1 and the non-overlapping signal generator U4. The charging and discharging circuit U5 can be configured to generate the temperature voltage Vtemp according to the positive-temperature-coefficient current Iptat, the frequency conversion signal Ftemp, and the inverted conversion signal Ftemp′.

The implementation of the frequency conversion module is illustrated as follows but is not limited to the description here. For example, as shown in FIG. 4, the positive-temperature-frequency conversion unit U1 can be a current-generating circuit. An output current of the current-generating circuit is positively correlated with temperature. For example, the positive-temperature-frequency conversion unit U1 is configured to generate the positive-temperature-coefficient current Iptat based on a positive temperature coefficient characteristic of a base-emitter voltage difference ΔVBE of the two transistors. For example, the base-emitter voltage difference ΔVBE of the two transistors is proportional to the absolute temperature, i.e., a temperature coefficient irrelevant to temperature or the characteristics of a collector current of the transistor. An output current Iptat of the positive-temperature-frequency conversion unit U1 is proportional to absolute temperature (PTAT), such as using a bandgap circuit or its associated functional circuit but not limited to the description here.

For example, as shown in FIG. 5, a positive-temperature-frequency conversion unit U1 includes two first transistors (e.g., PNP-type BJT transistors) Q₁ and Q₂, a resistor R₁, an operational amplifier unit OP, and three second transistors (e.g., P-type MOS transistors) Mₐ, M_{b}, and M_{c}. It should be understood that the transistors mentioned above are all three-terminal switch transistors, such as having a control terminal, an input terminal, and an output terminal. Also, a specific connection method is understandable by those skilled in the art and will not be described in detail.

For example, as shown in FIG. 5, in the current-generating circuit, control terminals and output terminals of the two first transistors Q₁ and Q₂ are grounded, an input terminal of the first transistor Q₁ is connected to an inverting terminal (“−”) of the operational amplifier unit OP and an output terminal of the second transistor Mₐ, an input terminal of the first transistor Q₂ is connected to a non-inverting terminal (“+”) of the operational amplifier unit OP and an output terminal of the second transistor M_{b} via a resistor R₁, an output terminal of the operational amplifier unit OP is connected to control terminals of the second transistor Mₐ, M_{b}, and M_{c}, and input terminals of the second transistor Mₐ, M_{b}, and M_{c} are connected to the positive power supply V_{DD}. The output terminals of the second transistors M a and Mb can provide bias currents to the first transistors Q₁ and Q₂. It should be understood that the currents flowing through the first transistors Q₁ and Q₂ are equal. In actual applications, a single specific transistor can be used as each of the first transistors Q₁ and Q₂ but is not limited to the description here. The first transistors Q₁ and Q₂ can also be regarded as two transistor modules that include “A” first BJTs and “nA” first BJTs connected in parallel, respectively (e.g., the current of a single first BJT forming the first transistor Q₁ is n times the current of a single second BJT forming the first transistor Q₂). An output terminal of the second transistor Mc can provide the positive-temperature-coefficient current Iptat.

It should be understood that, as shown in FIG. 5, the positive-temperature-frequency conversion unit U1 can utilize the positive-temperature-coefficient characteristic of the voltage difference ΔVBE between the base and the emitter of each of the first transistors Q₁ and Q₂ and the resistor R₁ to generate the positive-temperature-coefficient current Iptat. For example, R₁×Iptat=Vbe1−Vbe2=V_{T}×ln×n, wherein V_{T} is a positive-temperature-coefficient thermal voltage; In is a natural logarithm; n is a multiple formed by a PNP configuration of the two first transistors Q₁ and Q₂; each of Vbe1 and Vbe2 is a voltage difference between the base and the emitter of one of the two first transistors Q₁ and Q₂; V_{T} is a thermal voltage of each of the two first transistors Q₁ and Q₂, such that Iptat=(V_{T}×ln×n)/R₁. Thus, the current Iptat outputted by the positive-temperature-frequency conversion unit U1 is a current based on a positive temperature coefficient.

Alternatively, for simplifying types of components, the second transistors Ma, Mb and the operational amplifier unit OP in FIG. 5 can also be replaced by four MOS transistors.

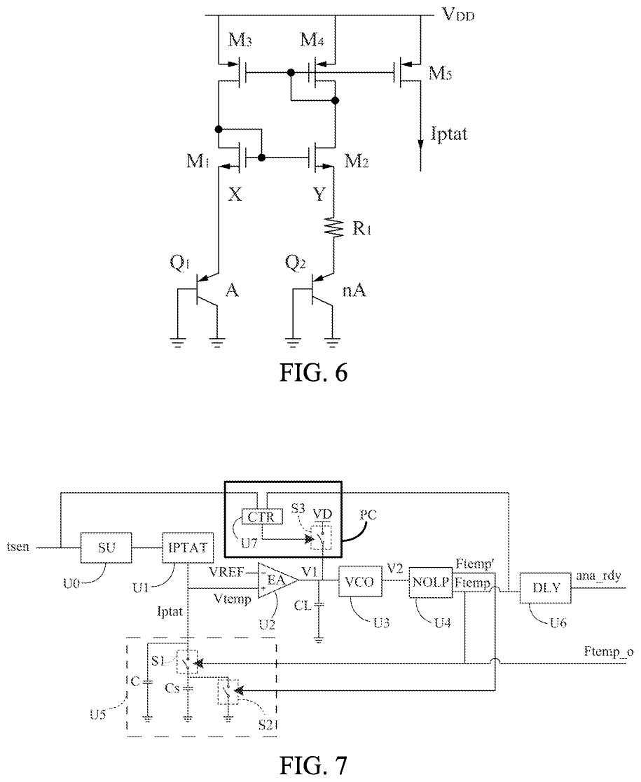

For example, as shown in FIG. 6, another positive temperature-frequency conversion unit U1 includes two first transistors (such as PNP-type BJT transistors) Q₁ and Q₂, a resistor R1, two second transistors (such as N-type transistors) MOS transistors) M₁ and M₂, and three third transistors (such as P-type MOS transistors) M₃, M₄, and M₅. Control terminals and output terminals of the first transistors Q₁ and Q₂ are grounded. An input terminal of the first transistor Q₁ is connected to the output terminal of the second transistor M₁. An input terminal of the second transistor M₁ is connected to the control terminals of the second transistor M₁ and M₂ and an output terminal of the third transistor M₃. An output terminal of the second transistor M₂ is connected to an input terminal of the first transistor Q₂, through the resistor R₁. An input terminal of the second transistor M₂ is connected to an output terminal of the third transistor M₄ and control terminals of the third transistors M₃, M₄, and M₅. Input terminals of the third transistors M₃, M₄, and M₅ are connected to a positive power supply V_{DD}. The output terminals of the second transistors M₁ and M₂ can provide bias currents to the first transistors Q₁ and Q₂. As mentioned, the currents flowing through the first transistors Q₁ and Q₂ are equal. The transistors Q₁ and Q₂ can be regarded as two transistor modules including “A” first BJTs and “nA” second BJTs connected in parallel, respectively (e.g., the current of a single first BJT forming the first transistor Q₁ is n times the current of a single second BJT forming the first transistor Q₂). An output terminal of the third transistor M₅ can provide the positive-temperature-coefficient current Iptat.

It should be understood that, as shown in FIG. 6, assuming that voltages at nodes X and Y are equal, the current flowing through the first transistor Q₁, the current flowing through the first transistor Q₂, and the current flowing through the third transistor M₅ (i.e., the positive-temperature-coefficient current Iptat) is equal to (V_{T}×ln×n)/R₁.

For example, as shown in FIG. 4, the operational amplifier U2 may include an operation-amplifying function circuit. An output terminal of the operational amplifier U2 may be provided with an op-amp capacitor CL for charging the operation-amplifying signal V1 outputted by the operational amplifier U2. The voltage-controlled oscillator U3 may include a voltage-controlled oscillation circuit for generating the oscillation signal V2 according to the operation-amplifying signal V1, such that a frequency of the oscillation signal V2 is positively correlated with amplitude of the operation-amplifying signal V1. The non-overlapping signal generator U4 may include a non-overlapping signal generator for generating the frequency conversion signal Ftemp and the inverted conversion signal Ftemp′ according to the oscillation signal V2 for subsequent control or output signals.

For example, as shown in FIG. 4, the charging and discharging circuit U5 includes a first capacitor Cs, a second capacitor C, a first switch S1, and a second switch S2. The first capacitor Cs and the first switch S1 are connected in series between the positive-temperature-frequency conversion unit U1 and a ground strap. The second capacitor C is electrically connected between the positive-temperature-frequency conversion unit U1 and the ground strap. The second switch S2 and the first capacitor Cs are connected in parallel between the first switch S1 and the ground strap.

For example, as shown in FIG. 4, the frequency conversion signal Ftemp is active to control the first switch S1 to be turned on. Meanwhile, the second switch S2 is turned off. The positive-temperature-coefficient current Iptat is used to charge the first capacitor Cs and the second capacitor C, such that the temperature voltage Vtemp increases, and the inverted conversion signal Ftemp′ is active to control the second switch S2 to be turned on. Meanwhile, the first switch S1 is turned off. The first capacitor Cs is discharged, but at the moment, the second capacitor C continues to be charged, such that the temperature voltage Vtemp continues to rise until the first switch S1 is turned on again, and the second switch S2 is turned off again, at the next moment. At the instant when the first switch S1 is turned on and the second switch S2 is turned off, the temperature voltage Vtemp has a situation of dropping voltage because there is no charge on the first capacitor Cs to be redistributed with the second capacitor C. Subsequently, the temperature voltage Vtemp will continue to be increased due to the charging for the first capacitor Cs and the second capacitor C. It is worth noting that, in other embodiments, the charging and discharging circuit U5 may further include another set of switches (e.g., a configuration similar to the first and second switches, not shown in the figure). This set of switches and the above switches S1 and S2 can alternatively control the capacitors Cs and C to be charged and discharged.

For example, as shown in FIG. 4, the frequency of the frequency conversion signal Ftemp_o is determined by the positive-temperature-coefficient current Iptat, the reference voltage, and the capacitance of the first capacitor Cs. For example, a frequency of the frequency conversion signal Ftemp_o=a frequency of the frequency conversion signal Ftemp=a current of the positive-temperature-coefficient current Iptat/(a voltage of the reference voltage VREF×the capacitance of the first capacitor Cs).

It should be noted that, as shown in FIG. 4, when the positive-temperature-coefficient current Iptat varies with temperature, the voltage of the operation-amplifying signal V1 generated by the operational amplifier U2 changes, such that the temperature voltage Vtemp at one of the input terminals (e.g., the non-inverting terminal, “+”) of the operational amplifier U2 approaches the reference voltage VREF at the other of the input terminals (e.g., the inverting terminal, “−”) of the operational amplifier U2. When the positive-temperature-coefficient current Iptat changes, that is, the charging current of the charging and discharging circuit U5 changes, the temperature voltage Vtemp will be dynamically maintained around the reference voltage VREF according to the negative feedback characteristics of a whole system. Namely, the temperature voltage Vtemp is stably approaching the reference voltage VREF, and the control frequency of the switches of the charging and discharging circuit U5 (i.e., the frequency of the frequency conversion signal Ftemp_o) changes accordingly through a closed-loop control configuration such as mentioned above.

It should be noted that, as shown in FIG. 4, the operational amplifier U2, the voltage-controlled oscillator U3, the non-overlapping signal generator U4, and the charge-discharge circuit U5 are connected to form a closed loop. The temperature change causes the positive-temperature-coefficient current Iptat to change, such that there is a difference between the temperature voltage Vtemp inputted by the operational amplifier U2 and the reference voltage VREF. The difference will be fed back to the subsequently formed temperature voltage Vtemp becoming stable through the closed loop. A process of gradually locking the temperature voltage makes the overall circuit of the frequency conversion module MF tend to be stable eventually. Also, the frequency of the frequency conversion signal Ftemp_o will change with the temperature and tend to be stable.

For example, as shown in FIG. 4, based on the working principle of a frequency-locked loop, the first capacitor Cs of the charging and discharging circuit U5 is charged and discharged through the positive-temperature-coefficient current Iptat. When the whole circuit finally reaches a stable state, the temperature voltage Vtemp will be controlled according to the frequency conversion signal Ftemp and the inverted conversion signal Ftemp′, such that the temperature voltage Vtemp tends to be stable around the reference voltage VREF, wherein the second capacitor C provides a voltage regulator effect. If the current of the charging and discharging circuit U5 (such as Iptat) of the charging and discharging circuit U5 changes with the temperature and still need to keep the temperature voltage Vtemp at the reference voltage VREF stably, then the frequency conversion signal Ftemp generated by the voltage-controlled oscillator will change accordingly, such that the frequency of the frequency conversion signal Ftemp_o changes with the temperature.

Additionally, in one embodiment, as shown in FIG. 4, the frequency conversion module MF further includes a delay unit (DLY) U6. The delay unit U6 is electrically connected to the non-overlapping signal generator U4. For example, in response to starting to generate the frequency conversion signal Ftemp for a preset time (e.g., 100 milliseconds, ms) or a count of rising edges or falling edges of a pulse wave of the frequency conversion signal Ftemp reaching a threshold (e.g., 100 to 500), the delay unit U6 generates a ready signal Ftemp_rdy, such as being in a high level or logic “1”. Still, it is not limited to the description; the ready signal can also be in a low level or logic “0”.

It should be understood that, as shown in FIGS. 1 and 4, the ready signal Ftemp_rdy of the delay unit U6 can be used as the frequency-converting ready signal ana_rdy outputted by the frequency conversion module MF to indicate the current state of the frequency conversion signal Ftemp_o being valid. For example, the frequency conversion module MF generates the frequency-converting ready signal ana_rdy to enable the temperature-sensing data processing module MC to process the frequency conversion signal Ftemp_o.

Additionally, in one embodiment, as shown in FIG. 4, the frequency conversion module MF further includes a startup unit (SU) U0. When a conversion enable signal tsen is in an enable state (such as being a high or low level), the startup unit U0 can be configured to generate a driving signal. For example, the startup unit U0 includes a startup transistor (such as a P-type MOS transistor). An output terminal (such as a drain) of the startup transistor can output an auxiliary driving signal to the control terminal (such as the gate) of the P-type MOS transistors in the positive-temperature-frequency conversion unit U1 (as shown in FIG. 5 or 6). It should be understood that the positive-temperature-frequency conversion unit can output current under regular operation. To ensure that the circuit initially works typically, the startup unit can also output an auxiliary driving signal. After a system continues to work usually, the startup unit stops working.

Additionally, in an embodiment, compared with the circuit shown in FIG. 6, a frequency conversion module MF, shown in FIG. 7, further includes a boost circuit PC. The boost circuit PC is configured to boost up the level of the operational amplifier signal V1 according to an enabling signal (such as tsen shown in FIG. 4) inputted from the outside and the frequency conversion signal Ftemp. For example, an output terminal of an operational amplifier U2 is electrically connected to an op-amp capacitor CL. The boost circuit PC includes a boost controller (CTR) U7 and a boost switch S3. The boost switch S3 is electrically connected to the boost controller U7, the op-amp capacitor CL, and a DC power supply VD.

For example, as shown in FIG. 7, the boost controller U7 is configured to control the boost switch S3 to be turned on according to the enable signal tsen, such that the DC power supply VD charges the op-amp capacitor CL through the boost switch S3. In addition, the boost controller U7 is configured to operate in response to starting generating the frequency conversion signal Ftemp. For example, in response to detecting the first rising edge or falling edge of the frequency conversion signal Ftemp, the boost switch S3 is controlled to be turned off to stop charging the op-amp capacitor CL.

In one aspect, the above-mentioned embodiments of the present disclosure provide a frequency conversion module, which includes: a positive-temperature-frequency conversion unit configured to generate a positive-temperature-coefficient current whose magnitude is positively correlated with temperature; an operational amplifier electrically connected to the positive-temperature-frequency conversion unit, wherein the operational amplifier generates an op-amp signal according to a temperature voltage and a reference voltage; a voltage-controlled oscillator electrically connected to the operational amplifier, wherein the voltage-controlled oscillator generates an oscillation signal according to the op-amp signal; a non-overlapping signal generator electrically connected to the voltage-controlled oscillator, wherein the non-overlapping signal generator generates a frequency conversion signal and an inverted conversion signal according to the oscillation signal, and a phase of the frequency conversion signal is opposite to a phase of the inverted conversion signal; and a charging and discharging circuit electrically connected to the positive-temperature-frequency conversion unit and the non-overlapping signal generator, wherein the charging and discharging circuit is configured to generate the temperature voltage according to the positive-temperature-coefficient current, the frequency conversion signal, and the inverted conversion signal. Therefore, in the circuit design mentioned above of the frequency conversion module in this embodiment, there is a high correlation between the oscillation frequency of the frequency conversion signal and temperature, which is not affected by the speed of the circuit. In addition, the oscillation frequency of the frequency conversion signal changing with the power supply voltage is slight, which can Improve measurement accuracy.

In another aspect, the above-mentioned embodiments of the present disclosure provide a temperature sensor, which includes a temperature-sensing data processing module and the above-mentioned frequency conversion module, wherein the frequency conversion module is electrically connected to the temperature-sensing data processing module, and the temperature-sensing data processing module generates a temperature value according to a frequency conversion signal. Therefore, a temperature value is generated according to the frequency conversion signal, wherein the temperature value is related to a frequency counting result of a single signal. Thus, it can reduce counting errors and improve measurement accuracy.

Optionally, in an embodiment, the frequency conversion module generates a frequency-converting ready signal to enable the temperature-sensing data processing module to process the frequency conversion signal. Therefore, the asynchronous signal situation due to counting different signals can be avoided by enabling the temperature-sensing data processing module to process the frequency conversion signal and generate a temperature value according to the frequency conversion signal. Thus, the counting error can be reduced, and the measurement precision can be improved.

It should be noted that the above embodiments of the present disclosure provide the frequency conversion module, which uses a current with a positive temperature coefficient to charge and discharge capacitors to generate a voltage signal with a positive temperature coefficient. In contrast, in a related example, e.g., a bandgap reference module is used to generate a bandgap reference voltage and a positive-temperature-coefficient voltage. Then, two identical voltage-frequency conversion circuits are used to convert the positive-temperature-coefficient voltage and the bandgap reference voltage into a positive-temperature-coefficient voltage frequency and a bandgap reference voltage frequency, respectively. Finally, two counters are used for counting, wherein a second counter reaches a full-counting number to make a first counter stop counting using a feedback signal. In addition, a ratio of the positive-temperature-coefficient voltage to the bandgap reference voltage is obtained to obtain the temperature value. In this example, because the frequency signal to be measured (e.g., the positive-temperature-coefficient voltage frequency) and the reference frequency signal (e.g., the bandgap reference voltage frequency) are completely asynchronous signals, there will be a significant error when the temperature is calculated according to counting values of the reference frequency signal and the frequency signal to be measured. The frequency conversion module of the above embodiments of the present disclosure generates a voltage signal with a positive temperature coefficient for charging and discharging capacitors to avoid the asynchronous signal situation using the bandgap reference module. Thus, it can achieve beneficial effects such as simplifying the circuit structure, reducing counting errors, and improving measurement accuracy.

Herein, the above content is only used as examples to illustrate the implementation of the temperature-sensing data processing module and the frequency conversion module of the embodiment of the present disclosure applied to realize the temperature sensor to enable readers to understand the present disclosure but is not limited to the description here.

In summary, the temperature sensor of the embodiment of the present disclosure includes a temperature-sensing data processing module and a frequency conversion module. In one embodiment, the frequency conversion module uses a current with a positive temperature coefficient to charge and discharge capacitors to generate a voltage with a positive temperature coefficient signal, in which an oscillation frequency has a high correlation with temperature and is not affected by the speed of the circuit. In addition, the oscillation frequency changing with the power supply voltage is slight. In another embodiment, the temperature-sensing data processing module uses two counting units to count rising and falling edges of the same signal frequency (such as from a counting-clock signal) to generate a temperature value according to a sum of the number of rising edges and the number of falling edges. Therefore, avoiding asynchronous signals causing counting errors between the frequency conversion signal and the reference clock signal is possible. In addition, because the rising and falling edges of the same signal frequency (e.g., the counting-sample signal) are simultaneously counted, it is equivalent to doubling the frequency of the counting-clock signal. The higher the frequency of the counting-clock signal, the smaller the sampling error and the smaller the errors of the counting measurement value. Thus, it can achieve beneficial effects such as reducing the counting error and improving measurement accuracy. The present disclosure can improve technical problems in the prior art, such as more significant errors generated according to the reference clock frequency and the counting value when a temperature value is calculated. Thus, it is conducive to improving the technical level and quality of temperature-sensing applications.

In the embodiments above, the descriptions of each embodiment have their emphases. For parts not described in detail in a specific embodiment, reference may be made to relevant descriptions of other embodiments.

The embodiments of the present disclosure have been introduced in detail above, and the principles and implementation methods of the present disclosure have been described using specific examples herein. The descriptions of the above embodiments are only used to help understand the technical solutions and core ideas of the present disclosure; The skilled person should understand that it is still possible to modify the technical solutions described in the preceding embodiments or perform equivalent replacements for some of the technical features; these modifications or replacements do not make the essence of the corresponding technical solutions deviate from the scope of the various technical solutions of the present disclosure.

1. A temperature-sensing data processing module, comprising:
two counting units, wherein each of the two counting units is configured to set one of a reference clock signal and a frequency conversion signal to be a counting-clock signal and the other of the reference clock signal and the frequency conversion signal to be a counting-sample signal according to a control signal, and during a sampling period consisting of at least one signal cycle of the counting-sample signal, one of the two counting units counts the number of rising edges of the counting-clock signal, and the other of the two counting units counts the number of falling edges of the counting-clock signal; and
a count-control unit configured to generate a doubled-frequency counting value based on a sum of the number of rising edges and the number of falling edges and generate a temperature value based on the doubled-frequency counting value and a temperature-frequency fitting function.

2. The temperature-sensing data processing module as claimed in claim 1, wherein the temperature-frequency fitting function is generated by fitting a plurality of temperature-frequency conversion relationship curves.

3. The temperature-sensing data processing module as claimed in claim 1, wherein in response to a frequency of the reference clock signal being higher than or equal to a frequency of the frequency conversion signal, the temperature-frequency fitting function is expressed as:
$$T = T 0 + ( ( \frac{2 \times F 1}{Y} ) \times N - U \times F 0 ) / E$$
wherein T is the temperature value, T0 is a reference temperature, F1 is the frequency of the reference clock signal, Y is the doubled-frequency counting value, N is the number of the signal periods of the counting-sample signal included in the sampling period, U is a frequency-unit conversion coefficient, F0 is a frequency value at the reference temperature, and E is a temperature-frequency conversion coefficient.

4. The temperature-sensing data processing module as claimed in claim 1, wherein in response to a frequency of the reference clock signal being lower than a frequency of the frequency conversion signal, the temperature-frequency fitting function is expressed as:
$$T = T 0 + ( ( \frac{F 1}{N} ) \times Y / 2 - U \times F 0 ) / E$$
wherein T is the temperature value, T0 is a reference temperature, F1 is the frequency of the reference clock signal, Y is the doubled-frequency counting value, N is the number of the signal periods of the counting-sample signal included in the sampling period, U is a frequency-unit conversion coefficient, F0 is a frequency value at the reference temperature, and E is a temperature-frequency conversion coefficient.

5. The temperature-sensing data processing module as claimed in claim 1, wherein in response to detecting the rising edge of the counting-sample signal for the first time at the rising edges of the counting-clock signal, the count-control unit is configured to determine that a first beginning of the sampling period is detected; and in response to detecting the rising edge of the counting-sample signal for the first time at the falling edge of the counting-clock signal, the count-control unit is configured to determine that a second beginning of the sampling period is detected.

6. The temperature-sensing data processing module as claimed in claim 1, wherein in response to detecting the rising edge of the counting-sample signal for the (N+1)th time at the rising edges of the counting-clock signal, the count-control unit is configured to determine that a first ending of the sampling period is detected; and in response to detecting the rising edge of the count sampling signal for the (N+1)th time at the falling edge of the counting-clock signal, the count-control unit is configured to determine that a second ending of the sampling period is detected, wherein N is the number of the signal periods of the counting-sample signal included in the sampling period.

7. The temperature-sensing data processing module as claimed in claim 5, wherein in response to detecting the counting-sample signal being in a low level first and then a high level at adjacent two of the rising edges or adjacent two of the falling edges of the counting-clock signal, the count-control unit is configured to determine that the rising edge of the counting-sample signal is detected.

8. The temperature-sensing data processing module as claimed in claim 1, wherein in response to a termination of the sampling period, the count-control unit resets the doubled-frequency counting value to zero.

9. The temperature-sensing data processing module as claimed in claim 1, wherein in response to a first beginning of the sampling period, the count-control unit is configured to generate a rising start-count signal; in response to a first ending of the sampling period, the count-control unit is configured to generate a rising stop-count signal; and one of the two counting units starts counting the number of rising edges of the counting-clock signal according to the rising start-count signal and stops counting the number of rising edges of the counting-clock signal according to the rising stop-count signal.

10. The temperature-sensing data processing module as claimed in claim 9, wherein in response to a second beginning of the sampling period, the count-control unit is configured to generate a falling start-count signal; in response to a second ending of the sampling period, the count-control unit is configured to generate a falling stop-count signal; and the other of the two counting units starts counting the number of falling edges of the counting-clock signal according to the falling start-count signal and stops counting the number of falling edges of the counting-clock signal according to the falling stop-count signal.

11. A temperature sensor, comprising a frequency conversion module and a temperature-sensing data processing module, wherein the temperature-sensing data processing module is electrically connected to the frequency conversion module, and the frequency conversion module is configured to generate a frequency conversion signal; wherein the temperature-sensing data processing module comprises:
two counting units, wherein each of the two counting units is configured to set one of a reference clock signal and the frequency conversion signal to be a counting-clock signal and the other of the reference clock signal and the frequency conversion signal to be a counting-sample signal according to a control signal, and during a sampling period consisting of at least one signal cycle of the counting-sample signal, one of the two counting units counts the number of rising edges of the counting-clock signal, and the other of the two counting units counts the number of falling edges of the counting-clock signal; and
a count-control unit configured to generate a doubled-frequency counting value based on a sum of the number of rising edges and the number of falling edges and generate a temperature value based on the doubled-frequency counting value and a temperature-frequency fitting function.

12. The temperature sensor as claimed in claim 11, wherein the temperature-frequency fitting function is generated by fitting a plurality of temperature-frequency conversion relationship curves.

13. The temperature sensor as claimed in claim 11, wherein in response to a frequency of the reference clock signal being higher than or equal to a frequency of the frequency conversion signal, the temperature-frequency fitting function is expressed as:
$$T = T 0 + ( ( \frac{2 \times F 1}{Y} ) \times N - U \times F 0 ) / E$$
wherein T is the temperature value, T0 is a reference temperature, F1 is the frequency of the reference clock signal, Y is the doubled-frequency counting value, N is the number of the signal periods of the counting-sample signal included in the sampling period, U is a frequency-unit conversion coefficient, F0 is a frequency value at the reference temperature, and E is a temperature-frequency conversion coefficient.

14. The temperature sensor as claimed in claim 11, wherein in response to a frequency of the reference clock signal being lower than a frequency of the frequency conversion signal, the temperature-frequency fitting function is expressed as:
$$T = T 0 + ( ( \frac{F 1}{N} ) \times Y / 2 - U \times F 0 ) / E$$
wherein T is the temperature value, T0 is a reference temperature, F1 is the frequency of the reference clock signal, Y is the doubled-frequency counting value, N is the number of the signal periods of the counting-sample signal included in the sampling period, U is a frequency-unit conversion coefficient, F0 is a frequency value at the reference temperature, and E is a temperature-frequency conversion coefficient.

15. The temperature sensor as claimed in claim 11, wherein in response to detecting the rising edge of the counting-sample signal for the first time at the rising edges of the counting-clock signal, the count-control unit is configured to determine that a first beginning of the sampling period is detected; and in response to detecting the rising edge of the counting-sample signal for the first time at the falling edge of the counting-clock signal, the count-control unit is configured to determine that a second beginning of the sampling period is detected.

16. The temperature sensor as claimed in claim 11, wherein in response to detecting the rising edge of the counting-sample signal for the (N+1)th time at the rising edges of the counting-clock signal, the count-control unit is configured to determine that a first ending of the sampling period is detected; and in response to detecting the rising edge of the count sampling signal for the (N+1)th time at the falling edge of the counting-clock signal, the count-control unit is configured to determine that a second ending of the sampling period is detected, wherein N is the number of the signal periods of the counting-sample signal included in the sampling period.

17. The temperature sensor as claimed in claim 11, wherein in response to a termination of the sampling period, the count-control unit resets the doubled-frequency counting value to zero.

18. The temperature sensor as claimed in claim 11, wherein in response to a first beginning of the sampling period, the count-control unit is configured to generate a rising start-count signal; in response to a first ending of the sampling period, the count-control unit is configured to generate a rising stop-count signal; and one of the two counting units starts counting the number of rising edges of the counting-clock signal according to the rising start-count signal and stops counting the number of rising edges of the counting-clock signal according to the rising stop-count signal.

19. The temperature sensor as claimed in claim 11, wherein a frequency of the frequency conversion signal is positively correlated with the temperature value.
